(19) United States
(12) Patent Application Publication
(10) Pub. No.: US 2014/0370178 A1
(43) Pub. Date: Dec. 18, 2014

(54) GLUTEN-FREE COOKING PRODUCTS

(71) Applicants: Bernard Boursier, Violaines (FR); Patrick Leroux, Estaires (FR)

(72) Inventors: Bernard Boursier, Violaines (FR); Patrick Leroux, Estaires (FR)

(73) Assignee: ROQUETTE FRERES, Lestrem (FR)

(21) Appl. No.: 14/376,218

(22) PCT Filed: Jan. 31, 2013
(86) PCT No.: PCT/FR2013/050207

§ 371 Date: Aug. 1, 2014

(30) Foreign Application Priority Data
Feb. 1, 2012 (FR) 12 50953

(51) Int. Cl. A21D 10/00; A21D 8/06

(52) U.S. Cl. CPC A21D 10/007; A21D 8/06
USPC 426/549; 426/653; 426/523

(57) ABSTRACT

The present invention relates to a composition for a gluten-free cooking product, and specifically for all products traditionally containing gluten, added as such or by way of bread flour, the products including, in particular, bakery products. The invention likewise relates to totally gluten-free cooking and/or bread products produced using the composition.

### FIELD OF THE INVENTION

The subject of the present invention is a composition for a baked product free of gluten, and more particularly all the products traditionally comprising gluten provided as such or by means of a bread flour, such as, in particular, leavened-dough or proofed-dough bakery products, also referred to as leavened-dough or proofed-dough breadmaking products, in particular traditional French bread, sandwich breads, English loaves, brioches, bread rolls, Viennese pastries, madeleines, gateaux, cakes, buns, pizza doughs, frozen pastries, unleavened pastas, and textured products for feeding animals.

The present invention also relates to the baked and/or breadmaking products totally free of gluten that are obtained by implementing the composition.

### TECHNICAL BACKGROUND

The history of bread begins in 8000 B.C. It is so old that it is not known exactly when human beings stopped roasting or boiling cereals, so as to make flour from them, knead it, bake and raise the first bread in history. Considered to be a gift from the gods in all the religions of the world, bread has taken such a place in human nutrition that, when it is lacking, or when it is too expensive, it can cause riots or revolutions. In the West, bread symbolizes the food and the right to eat of all people.

Bread is the result of very complex physical transformations, chemical reactions and biological activities which occur within a mixture of flour resulting from bread cereals, water, salt and yeast, and sometimes other ingredients (ascorbic acid, flours of other origins, exogenous enzymes, emulsifiers, etc.), under the action of a controlled input of mechanical and thermal energy. Only the yeast Saccharomyces cerevisiae is authorized.

The formulation differs with the types of bread. Traditional bread is free of sugar, milk and fat. Vienna bread contains, in addition to the ingredients found in traditional bread, sugar, fat and milk powder, but does not contain eggs. As for sandwich bread, it contains the same ingredients as Vienna bread, but in different proportions, with the optional presence of milk powder. Milk bread and brioche bread contain all the ingredients mentioned above with, in addition, the presence of eggs, but in different proportions.

French legislation classifies breads according to their composition and the technique used to produce them: traditional French bread, homemade bread, leavened bread, bread baked in a wood-fired oven, rustic bread, farmhouse bread, rye bread, bran bread, wheaten bread, common French bread.

To obtain bread, three components, the action of which is complementary and inseparable, must be brought together:
starch, which provides the sugars,
gluten, which forms the fine elastic network and provides cohesion of the whole, and
yeast, which produces, as its name in French (“levure”) indicates, the raising (in French, “levee”) and the lightening of the dough.

Only wheat provides both starch and gluten (there is little of it in rye). The gluten precursors are dispersed in the flour and extensive blending work is required in order to bring them together: this is the role of kneading. The purpose of the latter is not simply to mix the ingredients, but especially to crosslink the gluten so as to give the dough body. Furthermore, only the soft wheats have this property. Their flour is also called soft wheat flour.

It takes approximately five hours to produce traditional French bread, and said production comprises various key steps. The first step in production, which is kneading, makes it possible to obtain a dough of predetermined consistency, by kneading water, yeast and flour in the presence of air. Carrying out the operation in the correct manner conditions to a great extent the quality of the final products. It makes it possible to form a homogeneous, smooth, tenacious and viscoelastic dough from its two main constituents, namely flour and water, and within which the starch, gluten and air would take up respectively 60%, 30% to 10% of the total volume. During this operation, the dough is subjected to strong extension, compression and shear forces which depend on the geometry of all of the parts of the kneading machine, on the speed of rotation of the arms, and also on its rheological properties. When water and flour are kneaded, the mixture undergoes a considerable change: the particles of flour become hydrated, the mixture loses its wet and granular nature, and the dough forms, becomes smooth and homogeneous, and firms up.

There is an optimum rheological state for the dough which gives the best assurance of the quality of the final products, and the job of manufacturers will be exactly to develop their formulas and to regulate their machines so as to achieve this optimum state.

The second step, called bulk fermentation, is a resting or first fermentation step, during which the yeasts multiply. It is a decisive step for the development of the elastic properties of the dough and of the future flavours of the bread. The carbon dioxide produced by the yeasts is trapped in the gluten network, thereby making the dough very elastic.

It is then time for the forming, also called “the turn”, which comprises mechanical operations of weighing, dividing the dough and shaping dough pieces.

The dough pieces shaped must be left to stand once more. This is the proving or second fermentation, which allows expansion of the volume of the dough.

Finally, the last phase consists of the transformation of the fermented dough into bread, by putting it in an oven, the temperature of which is fixed at around 250° C.

Thus, gluten has a predominant role in making doughs, and more particularly in making bread. It must first have good water-absorption capacities. The dough piece is the result of mixing flour and water. The gluten proteins must be able to absorb sufficient water to form the dough, which must subsequently have enough resistance against the blending process. The gluten must also be able to be extensible. In a bread dough, during fermentation, i.e. while the dough rises, carbon dioxide is produced following consumption of sugars by the yeasts. The gas produced inside the dough will stretch the gluten matrix, form gas bubbles and allow the dough to rise. If the gluten is not sufficiently elastic, the gas bubbles will burst and the dough will not rise. Finally, the gluten must show a certain amount of resistance. It is this resistance which will enable the gas to be maintained in the dough until the baking process establishes the structure of the dough. A good balance between elasticity and extensibility is necessary in order to have a gluten of quality. It is this which enables the gluten network to form during production, making it possible to obtain, in the end, a voluminous and aerated bread. It can absorb two to three times its own weight in water and, after hydration, it is characterized by its ability to form an elastic, extensible and impermeable network. It performs various functions: increase in flour yield, improvement in the gluten network and in gas retention, improvement in dough piece development and increase in proving time.

Gluten is a mixture of proteins combined with starch in the endosperm of most cereals. It constitutes approximately 80% of the proteins contained in wheat. Gluten is divided up into two groups: prolamins (gliadins in wheat), responsible for very pernicious coeliac disease and intolerance, and glutenins.

Cereals containing these two types of insoluble proteins are described as cereals suitable for breadmaking.

Among them, wheat or soft wheat or spelt (alpha-gliadin), rye (secalin) and barley (hordenine) are the most toxic, followed by maize (zenin).

Gluten has for a long time been acknowledged to be a major allergen/antigen, and is responsible for coeliac disease, which is nowadays one of the most common digestive diseases. It affects approximately one child in 2500 in France. This gluten intolerance, called gluten enteropathy or hypersensitivity, is a chronic autoimmune disease which is more or less serious depending on the degree of manifestation. Although the exact biological mechanisms have not yet been completely elucidated at the current time, it is nevertheless known that it is an autoimmune disease: upon contact with the gluten contained in the diet, the body produces autoantibodies which will cause lesions responsible for the disorders. It is the small intestine which is mainly affected, and more specifically the mucosa that lines it. In a healthy individual, this mucosa consists of countless villi, i.e. folds in the shape of the fingers of a glove which considerably increase the surface area for absorption of food. In coeliac disease, the villi are destroyed and the mucosa becomes flat. The term villous atrophy is used. The manifestations of the disease vary greatly from one individual to the other, especially in adults.

In infants and small children, a few weeks or a few months after the introduction of gluten (which generally takes place at around 6 months), substantial diarrhoea, flatulence, a loss of appetite, vomiting, grumpiness, a loss of weight or a break in the weight curve, a state of undernourishment, or even a state of dehydration if the diagnosis is not made quickly, are conventionally observed.

In older children and adults, the malabsorption may not be as great and may cause only specific deficiencies in iron, proteins, vitamins and mineral salts, and make the diagnosis more difficult to establish. A more or less severe anaemia owing to a lack of iron, oedema owing to a lack of proteins, spontaneous fractures owing to a lack of calcium and of vitamin D, and spontaneous haemorrhages and hematomas owing to a lack of vitamin K may thus be observed. A symptom which is very common in adults, but which may have many causes, is chronic fatigue. This may be due to one or more deficiencies, but also solely to the autoimmune process which exhausts the body.

Digestive disorders, although they are almost always present and to the forefront in infants and children, are encountered only in less than half of affected adults, and cover both constipation and diarrhoea, bloating or abdominal pain, difficult digestion or “burning” due to gastro-oesophageal reflux. Secondary lactose intolerance is often observed in addition to this, because the enzyme which makes it possible to digest lactose is found in the villi, which are destroyed by coeliac disease.

Among the other disorders, mention is also made of nervous depression (which can go as far as suicide!), various neurological disorders, joint pain, sterility, miscarriages, migraine, aphthous stomatitis and alopecia. Finally, dermatitis herpetiformis is also a possible expression of coeliac disease.

The treatment of coeliac disease is, a priori, easy and, in practice, difficult. It is easy because it comprises no medicaments, no operation and very slight monitoring. The only treatment for coeliac disease consists in following a strict gluten-free diet for life. It is difficult because the diet is laborious to follow, expensive, very restrictive, and has repercussions on the social and psychological life of the coeliac patient.

The gluten in question is present in wheat (or soft wheat), rye, spelt, barley and sometimes oats, which are part of the composition of many foods. Gluten-intolerant individuals must therefore be very careful when choosing common food products.

Gluten may be present in direct form (flour) or through contamination (this is the case for the French oats circuit, which is too polluted with the cereals in question to be able to be suitable in a strict gluten-free diet). The diet will be followed for life, since described cases in which individuals have been cured are extremely rare and, even in this case, a relapse is always possible. In return for this diet, the person with coeliac disease is no longer ill and is safe from the complications, which can be disastrous.

People with coeliac disease are therefore constantly searching for new products which are totally gluten free. Many studies have been published on breadmaking processes, or on food preparations such as bread of pastries, which are devoid of gluten, and which can be used as foods for people with coeliac disease.

Currently, manufacturers are striving to produce substitute baked products, and more particularly substitute breadmaking products, obtained using gluten-free flour.

The products obtained are called, by analogy, gluten-free “breads”, and have an internal honeycomb structure that is visually reminiscent of that of the crumb of traditional bread.

However, gluten, which is a protein substance naturally present in wheat flour, rye flour or the like, is a vector essential to breadmaking. As previously explained, gluten also increases the hydration of the dough since it is capable of fixing approximately twice its weight of water. Furthermore, it plays a predominant role in the complex breadmaking process, where it makes it possible in particular to trap the gas bubbles produced by the fermentation of the yeast, the leaven or from the production of gas by another raising agent (chemical agent, for example), while the bread dough rises, providing, after baking in an oven, a bread crumb with a particularly light honeycomb internal structure which singularly characterizes the bread.

The production of gluten-free baked products of satisfactory quality is therefore a real challenge that manufacturers have today not yet completely succeeded in overcoming.

The majority of the research studies relate to breadmaking products more commonly referred to as gluten-free substitute breads.

Thus, in order to produce gluten-free baked products of satisfactory quality, a large number of special flours, starches and other substances, such as enzymes, proteins, polymers and hydrocolloids, have been used to mimic the viscoelastic properties of gluten.

Sometimes, in order to overcome the absence of gluten in the baked products and more particularly in all the products traditionally comprising gluten provided as such or by means of a bread flour, such as in particular breadmaking products, it has been sought to replace the traditional wheat flour with potato starch, corn starch or the like, to which a thickener and an emulsifier have been added so as to make it possible to retain the gas bubbles resulting from the fermentation of the yeast and to thus create a honeycomb structure composed of a large number of small gas cells.

This is, for example, the case for the gluten-free food preparations such as bread or pastries, proposed in French Patent FR 2 765 076, which describes a novel composition for preparing a gluten-free bread which has a crumb structure with numerous small gas cells distributed evenly in the mass of the bread, which composition is free of egg and of albumin, so as to have qualities as close as possible to “traditional” bread. The compositions described in FR 2 765 076 comprise a mixture of potato flour and/or rice flour, a thickener as substitute for gluten, advantageously chosen from alginates, xanthan, guar, locust bean or carrageenan flour, hydroxypropyl methyl cellulose, or mixtures thereof, an emulsifier, fat, baker's yeast, sugar and salt. FR 2 765 076 also describes a novel process for producing a gluten-free bread, including a homogenization step consisting in compressing the dough at a pressure of several tens of bar, before the raising step during which the dough will rise.

Other compositions for preparing gluten-free bread have been further proposed for obtaining a uniform honeycomb internal structure comprising a large number of gas cells. For example, document EP 0 642 737 describes a process for producing a gluten-free “bread” in which development of the dough is observed. In this document, said gluten-free bread is made of gluten-free flour, egg, chemical yeast and/or baker's yeast. Because it contains egg, the resulting food product can firstly be allergenic in nature, and does not correspond to the definition of traditional bread.

In document U.S. Pat. No. 4,451,491, a gluten-free bread is prepared from non-wheat-based starch, a gluten-substitute gum, an emulsifier, fat and sodium bicarbonate or chemical yeast.

All the examples described for forming the “bread” according to this invention use, in addition, egg powder possibly supplemented with albumin. The allergenic nature of egg is again present and the recipes used do not make it possible to obtain a bread in accordance with the regulatory definition.

Document US 2008/0038434 describes gluten-free compositions requiring the presence of polymers as a replacement for said gluten. The polymeric composition described comprises a gas-retaining polymer which can be chosen from polyacrylic acid, polyvinyl alcohol, polyvinyl acetate, and polyethylene polyisobutylene, and also a setting agent which can be chosen from polycaprolactone, polylactic acid and polyvinyl alcohol. The presence of these polymers in the compositions gives said formulations an unnatural nature, which is all the same highly desired by consumers.

Many gluten-free breads of the prior art contain hydrocolloids. The latter are high-molecular-weight polysaccharides extracted from plants or from algae, or produced by microbial synthesis, and which are widely used in the food industry in many applications, for example that of texturing agents. In the baked products, and more particularly breadmaking products, industry, hydrocolloids, for instance hydroxypropyl methyl cellulose (HPMC) and xanthan and guar gums, are quite widely used to increase the specific volumes of the breads and to improve the sensory characteristics of the final products.

On the other hand, the presence of hydrocolloids in the dough implies an adaptation of the amount of water in the recipe in order to make it possible to correctly hydrate all the other soluble compounds also present. Indeed, hydrocolloids are additives that it is necessary to strongly hydrate in order to develop their properties. Thus, the amount of water will have to be increased up to 100 g, or even 120 g, per 100 g of flour used. The hydration rate of a dough of a gluten-free bread is from to 1.2. When a conventional flour-based bread containing gluten is produced, the hydration rate is between 0.5 and 0.7, i.e. between 50 and 70 g of water per 100 g of flour used.

Consequently, the doughs of gluten-free breads have, visually, a consistency that is closer to a thick cake mixture than a conventional bread dough that it is easy to shape and to roll. Moreover, in order to prevent the dough from spreading during baking, the current gluten-free breads are baked in moulds. This major disadvantage does not allow the use of a conventional breadmaking process similar to that used in the production of a traditional bread. This constitutes another concern for manufacturers, which are obliged to modify their industrial process, both in terms of the recipes and in terms of the virtually obligatory use of moulds in the production line.

Thus, these processes for obtaining gluten-free bread which draw their inspiration from the principle of making traditional bread, i.e. of producing the honeycomb structure of the crumb via the production of gas by the yeast (and/or by the chemical yeast), do not make it possible to obtain a satisfactory honeycomb structure of the crumb, such that, unlike traditional bread, breads which have a compact overall appearance with an unsatisfactory specific volume are in reality obtained. Furthermore, some recipes for these gluten-free breads involve foods which have an allergenic nature. This is the case for egg, for example. Other compositions use compounds which are not at all natural. This is the case for compositions containing polymers obtained by heavy chemical synthesis.

Furthermore, many gluten-free breads suffer from a considerable loss of moisture content during storage, resulting in rapid hardening of the “bread” especially in terms of its crust. Moreover, because there is only a very limited number of gluten-free bread producers, this product is commonly sold by mail order and it is consumed at best one day after it is produced, which leads to a lack of freshness that greatly accentuates the impression that the bread is dense.

Finally, the production of gluten-free bread of the prior art implies the addition of HPMC or gums (guar, xanthan, etc.) which must be marked as additives on the packaging of the final product, in the ingredients. However, having additives in the list of ingredients of a food product is becoming ever less desired by consumers looking for natural solutions. Manufacturers consequently seek to avoid the use of food additives in their products.

From all the aforementioned, it follows that there is a real, unsatisfied need to have a composition used as a gluten substitute in baked products, and more particularly in breadmaking products, having several advantageous functional properties allowing it to avoid, or at the very least limit the number of additives used in the production of said baked products, while at the same time providing it with technological characteristics similar to those obtained in a traditional recipe for producing breadmaking products containing gluten.

Said composition will also have to make it possible to use “conventional” breadmaking processes, without requiring extensive modifications or the use of moulds for baking. Thus, the novel composition may also allow bakers to prepare gluten-free breads without any heavy investment and without any substantial modification of their production process used conventionally and daily.

Armed with this observation and after a considerable amount of research studies, the applicant company has, to its credit, overcome all the drawbacks previously described by proposing a novel composition for a totally gluten-free baked product.

Through the use of a native pregel starch in the formula, in combination with a fibre of vegetable origin, the gluten-free baked product obtained, and more particularly the gluten-free breadmaking product obtained with or without raising agent, has all the physical and organoleptic characteristics of the traditional breadmaking product, and in particular has a honeycomb internal structure reminiscent of that of the crumb of traditional bread.

Another object of the present invention makes it possible to obtain a gluten-free fresh bread devoid of any additive.

### SUMMARY OF THE INVENTION

A subject of the present invention is a composition for a gluten-free baked product comprising:
a pregelatinized or precooked native starch,
fibres of vegetable origin chosen from leguminous plant fibres.

Another object of the present invention makes it possible to obtain a gluten-free baked product devoid of any additive.

The present invention also relates to the process for obtaining this baked product.

Finally, the present invention also relates to a mix combining all the essential ingredients and which can be sold for home use with breadmaking machines, for example.

### DETAILED DESCRIPTION OF THE EMBODIMENTS

A subject of the present invention is a composition for a gluten-free baked product, and more particularly for all the products traditionally comprising gluten provided as such or by means of a bread flour, such as, in particular, leavened-dough or proofed-dough bakery products, also referred to as leavened-dough or proofed-dough breadmaking products, in particular traditional French bread, sandwich breads, English loaves, brioches, bread rolls, Viennese pastries, madeleines, gateaux, cakes, buns, pizza doughs, frozen pastries, unleavened pastas, and textured products for feeding animals, said gluten-free baked products comprising a pregelatinized or precooked native starch and fibres of vegetable origin chosen from leguminous plant fibres.

The applicant has, to its credit, found that the use of a native pregel starch in combination with a fibre of vegetable origin chosen from leguminous plant fibres in a gluten-free baked product formula makes it possible to obtain a product which has all the organoleptic characteristics of a baked product obtained according to a formula containing gluten.

This is the first time that such a combination has been described and used in the production of a baked product not containing gluten.

According to one preferential embodiment of the present invention, the composition for a gluten-free baked product is characterized in that it also comprises a non pregelatinized or non precooked gluten-free starch.

According to one preferential embodiment of the present invention, the composition for a gluten-free baked product is characterized in that it also comprises proteins of vegetable origin.

The addition of proteins to the composition makes it possible, inter alia, to nutritionally balance the final product obtained after baking. Indeed, the addition of proteins makes it possible to supplement said product with one of the essential nutrients of the diet, and makes it possible to propose a ready-to-eat product which has advantageous nutritional characteristics, both by virtue of its protein content and also by virtue of its fibre content.

The food industry has developed a series of products presented as being “gluten free” or described in equivalent terms. The removal of gluten from the cereals that contain it presents considerable technical difficulties and economic constraints, and the production of foods that are totally gluten free is therefore difficult. Consequently, many food products intended for this particular diet that exist on the market may contain small residual amounts of gluten. The conditions for use of the terms relating to the absence of gluten have been completely established in regulation (EC) No. 41/2009 and also in the Codex Alimentarius Manual in the standard CODEX STAN 118-1979, revised in 2008.

Thus, gluten-free foods are foods:
composed of or produced from one or more ingredients which do not contain wheat (namely all the species of Triticum, such as durum wheat, spelt and kamut), rye, barley, oats or crossed varieties thereof, the gluten content of which does not exceed 20 ppm, i.e. 20 mg/kg in total, on the basis of the foods as sold or distributed to the final consumer, and/or
consisting of one or more ingredients derived from wheat (namely all the species of Triticum, such as durum wheat, spelt and kamut), rye, barley, oats or crossed varieties thereof, which have been specially treated to remove the gluten, and the gluten content of which does not exceed 20 ppm, i.e. 20 mg/kg, in total.

In the present invention, the non pregelatinized or non precooked gluten-free starch used is a starch in which the gluten content does not exceed 20 mg/kg.

The quantitative determination of the gluten content in foods or their ingredients must be based on an immunological method or any other method which guarantees an at least equivalent sensitivity and specificity. The antibody to be used must react with the protein fractions of cereals which are toxic to gluten-intolerant individuals, and must not interact with other cereal proteins or other constituents of the foods or of their ingredients.

The quantitative analysis indicating the presence of gluten is based on the ELISA R5 method (termed Mendez method), which is an enzymatic immunoabsorption method, validated at the CODEX/INTERNATIONAL level.

In the present invention, the gluten-free starch used is chosen from the group made up of unmodified gluten-free starches, modified gluten-free starches or a mixture of the two.

In the present invention, the term “gluten-free starch” is intended to mean any starch obtained from raw materials which are by nature gluten free, and also any starch obtained from raw materials made “gluten free” by means of special treatments, well known to those skilled in the art. For example, the gluten may be extracted from flours naturally containing it by washing the starch. The dough obtained is rinsed and blended until the rinsing water becomes clear and is free of starch.

A gluten-free starch obtained from a botanical source which basically does not contain gluten will preferably be used. It may be, for example, chestnut starch, starch from cereals such as maize, millet, buckwheat, oats, tapioca, sorghum or rice, which may or may not be brown, starches from tuberous plants such as potato or cassaya, starches from leguminous plants such as pea, lentils and soybean, or starches from Chenopodiaceae, such as quinoa or amaranth, or starches rich in amylose or, conversely, rich in amylopectin (waxy), derived from these plants, and any mixtures of the abovementioned starches.

The starch selected for preparing the gluten-free starch may also be of any botanical origin, not containing gluten, provided that it undergoes a particular gluten removal process. Thus, the starches derived from wheat (or soft wheat or spelt), from barley, from rye or from triticale (wheat+rye) can also be used, provided that they are indeed gluten free after the extraction processes carried out.

In the present invention, said composition for a gluten-free baked product is characterized in that the content of pregelatinized or precooked native starch is between 2 and 50%, preferably between 5 and 30% and more preferentially between 7 and 18% of the total weight of the ingredients used in the recipe for preparing said baked product.

In the present invention, said gluten-free baked product is characterized in that the content of fibres of vegetable origin is between 2 and 50%, preferably between 5 and 30% and more preferentially between 7 and 18% of the total weight of the ingredients used in the recipe for preparing said baked product.

In the present invention, said gluten-free baked product is characterized in that the content of proteins of vegetable origin is between 0.5 and 20%, preferably between 0.8 and 10%, and more preferentially between 1 and 7% of the total weight of the ingredients used in the recipe for preparing said baked product.

In the present invention, the terms “baked product” and “breadmaking product” and also the term “bakery” should be interpreted broadly, as referring generally to the field of the production of oven-baked products from starch-based fermented doughs, and also to the bakery and Viennese pastry fields.

In the present invention, the terms “pregelatinized starch” and “precooked starch” are used without distinction to denote any native starch which has undergone heat treatment in the presence of water, such that it completely loses its granular structure and that it becomes soluble in cold water.

Thus, for the purpose of the invention, the term “pregelatinized starch” or “precooked starch” is intended to mean a state in which the starch is no longer in a granular state, i.e. in a state where it is no longer in a state of semi-crystalline granules characteristic of the state in which it is naturally present in the storage organs and tissues of higher plants, in particular in the seeds of cereals, the seeds of leguminous plants, the tubers of potato or of cassaya, roots, bulbs, stems and fruits. This semi-crystalline state is essentially due to the macromolecules of amylopectin, one of the two main constituents of starch. In the native state, starch grains have a degree of crystallinity which varies from 15 to 45%, and which essentially depends on the botanical origin and the optional treatment that it has undergone. Granular starch, placed under polarized light, exhibits, by microscopy, a characteristic black cross, referred to as a “Maltese cross”. This positive birefringence phenomenon is due to the semi-crystalline organization of these granules: the average orientation of the polymer chains is radial. For a more detailed description of granular starch, reference may be made to Chapter II entitled “Structure et morphologie du grain d'amidon” [“Structure and Morphology of the Starch Grain” by S. Perez, in the book “Initiation a la chimie et a la physico-chimie macromoleculaires” [“Introduction to macromolecular chemistry and physiochemistry”], First Edition, 2000, Volume 13, pages 41 to 86, Groupe Francais d'Etudes et d'Applications des Polymeres [French Group for Polymer Studies and Applications].

According to the present invention, the starch used for preparing said pregelatinized starch is always a native starch, and has not therefore undergone any prior treatment or modification.

The pregelatinized state of the starch is obtained by cooking granular starch, by incorporating water and by providing thermal and mechanical energy. The destructuring of the semi-crystalline granular state of the starch results in amorphous pregelatinized starches with disappearance of the Maltese cross produced under polarized light.

In the present invention, the pregelatinized starch preferably has a degree of crystallinity of less than 15%, preferably less than 5% and even more preferentially less than 1%, i.e. it is in an essentially amorphous state.

This degree of crystallinity can in particular be measured by X-ray diffraction, as described in patent U.S. Pat. No. 5,362,777 (column 9, lines 8 to 24).

According to one preferential embodiment of the present invention, the pregelatinized starch is advantageously substantially devoid of grains of starch having, by microscopy under polarized light, a Maltese cross, which is a sign indicating the presence of semi-crystalline granular starch.

The pregelatinized starches according to the present invention can be obtained by hydrothermal gelatinization treatment of native starches, in particular by steam cooking, cooking with a jet-cooker, cooking on a drum, cooking in blender/extruder systems followed by drying, for example in an oven, with hot air on a fluidized bed, on a rotating drum, by atomization, by extrusion or by lyophilization. Such starches generally have a solubility in demineralized water at 20° C. of greater than 5%, and more generally between 10 and 100%, and a degree of starch crystallinity of less than 15%, generally less than 5%, and most commonly less than 1%, or even zero. By way of example, mention may be made of the products produced and sold by the applicant under the brand name PREGEFLO®.

The starch selected for preparing the native pregelatinized starch may be of any botanical origin not containing gluten or in which the gluten content does not exceed 20 mg/kg. Thus, starches derived from wheat (or soft wheat or spelt), from barley, from rye or from triticale (wheat+rye) are generally to be excluded since they contain gluten, unless the processes for preparing them have made it possible to completely remove the gluten. There are in fact wheat starches that are guaranteed to be gluten free, obtained by means of a very particular process. Preferentially, a botanical source basically containing no gluten will be used for preparing the native pregelatinized starch. It may, for example, be starch from cereals such as maize, millet, buckwheat, oats, tapioca, sorghum or rice, from tuberous plants such as potato or cassaya, or from leguminous plants such as pea and soybean, starches rich in amylose or, conversely, rich in amylopectin (waxy), derived from these plants, and any mixtures of the abovementioned starches.

According to the present invention, said composition for a gluten-free baked product comprises a gluten-free starch chosen from the group made up of unmodified gluten-free starches, modified gluten-free starches or a mixture of the two.

According to one particularly advantageous embodiment of the present invention, said composition does not contain any additive. This means that the gluten-free starch is an unmodified starch.

Nowadays, virtually all the cooked baked products not containing gluten that are on the market are products containing food additives in large amounts (emulsifiers in particular). Indeed, in order to give the consistency and the texture generally provided by gluten, the recipes of gluten-free baked products very often contain gums, of guar, xanthan or HPMC (hydroxypropyl methyl cellulose) type. However, one of the current preoccupations of consumers relates to health, and there is a particular sensitivity with regard to the addition of additives to food products during their production. Consumers would prefer additive-free products, even if it means paying a little more for them. It is for consumers the guarantee of a healthy food that does not present any risks to their health and to that of their family.

One of the particularly advantageous aspects of the present invention is that it meets these various requirements completely since it makes it possible to obtain a gluten-free baked product which does not comprise any additive.

In the present invention, the term “additive” is used to denote all food additives, used in food products intended for consumption.

Generally, additives are all the numerous substances added to an industrial food product. Very restricted by legislation, many of them are regularly called into question. The definition of additives is very precisely given in the Codex Alimentarius Manual.

A “food additive” refers to any substance which is not normally consumed as a food product per se and is not normally used as a characteristic ingredient of a food product, whether or not it has a nutritive value, and the intentional addition of which to the food product for technological or organoleptic purposes, at any stage of the production, transformation, preparation, treatment, conditioning, packaging, transport or storage of said product, leads or may lead (directly or indirectly), to its incorporation, or that of its derivatives, into the product or can affect in another way the characteristics of said product. The expression applies neither to contaminants, nor to substances added to food products for the purpose of maintaining or improving the nutritive properties thereof, nor to sodium chloride.

The more the food industry has become industrialized, the more synthetic or natural additives have been used. The list of additives is now extremely long: there are more than 300 of them which are authorized and restricted by legislation. The additives are listed by the letter E followed by three numbers, the first of which indicates its category.

It is difficult to give a rigorous structure to the classification given by the various texts: indeed, on the one hand, new additives may appear and, on the other hand, some additives have several properties. Additives are generally classified according to the effect that they cause on the food. Council framework directive 89/107/EEC of 21 Dec. 1988 refers to 24 categories of additives, among which are emulsifiers, modified starches and flour treatment agents.

Everything is regulated, from the amounts used based on the principle of the ADI (Acceptable Daily Intake) to the labelling, including the foods that can receive some additive or another. Any additive, even if it is not used directly in the production of a product, must be indicated in the labelling.

Thus, according to one particularly advantageous embodiment of the present invention, said composition for a gluten-free baked product comprises a pregelatinized native starch, fibres of vegetable origin chosen from leguminous plant fibres and an unmodified gluten-free starch. This particularly advantageous embodiment makes it possible to obtain, for the baked product obtained from this composition not comprising any additive, the designation “Clean Label”, attesting to the fact that the ingredients used are completely natural and that there is a complete absence of any additive.

For the purposes of the present invention, the term “additive” comprises any additive as defined above, with the exclusion of pregelatinized or precooked native starches, gluten-free starches, fibres of vegetable origin, in particular leguminous plant fibres and quite particularly pea fibres, and proteins of vegetable origin, in particular leguminous plant proteins and quite particularly pea proteins, as defined in the present invention.

In the present invention, the term “fibres of vegetable origin” denotes soluble and/or insoluble vegetable dietary fibres. The latter denote not only fibrous materials in the strict sense, but also an entire series of different compounds which are contained almost exclusively in foods of vegetable origin and which have the common property of not being able to easily broken down by human digestive enzymes. Almost all dietary fibres are carbohydrate polymers. For several years, nutritionists have been interested in a new type of dietary fibres: resistant starch. It is a starch or starch fraction which is not digested in the small intestine and which is fermented by the bacteria of the colon.

Unlike traditional vegetable fibres, these starches have the advantage of not modifying the appearance of the product into which they are incorporated, and constitute as it were a source of fibres that is invisible to the naked eye. These starches are recommended in many applications.

Thus, the composition according to the present invention may comprise vegetable fibres chosen from soluble fibres, insoluble fibres and any mixtures thereof.

According to one advantageous embodiment of the present invention, the gluten-free and additive-free baked product comprises pea proteins and at least one vegetable fibre chosen from leguminous plant fibres.

According to another advantageous embodiment of the present invention, the composition for a gluten-free baked product comprises a mixture of at least one soluble vegetable fibre and of at least one insoluble vegetable fibre chosen from leguminous plant fibres.

Preferably, said soluble fibre of vegetable origin is chosen from the group made up of fructans, including fructooligosaccharides (FOSs) and inulin, glucooligosaccharides (GOSs), isomaltooligosaccharides (IMOs), trans-galactooligosaccharides (TOSs), pyrodextrins, polydextrose, branched maltodextrins, indigestible dextrins and soluble oligosaccharides derived from oleaginous plants or protein-producing plants.

The term “soluble fibre” is intended to mean fibres that are soluble in water. The fibres can be assayed according to various AOAC methods. By way of example, mention may be made of AOAC methods 997.08 and 999.03 for fructans, FOSs and inulin, AOAC method 2000.11 for polydextrose, AOAC method 2001.03 for assaying the fibres contained in branched maltodextrins and indigestible dextrins, or AOAC method 2001.02 for GOSs and also soluble oligosaccharides derived from oleaginous plants or protein-producing plants. Among the soluble oligosaccharides derived from oleaginous plants or protein-producing plants, mention may be made of soya, rapeseed or pea oligosaccharides.

According to one advantageous embodiment of the present invention, the composition for a gluten-free baked product comprises soluble vegetable fibres which are branched maltodextrins.

The term “branched maltodextrins” is intended to mean the specific maltodextrins identical to those described in patent EP 1 006 128-B1 of which the applicant is the proprietor. These branched maltodextrins have the advantage of representing a source of indigestible fibres beneficial to the metabolism and to the intestinal equilibrium. In particular, use may be made of branched maltodextrins having between 15% and 35% of 1-6 glucosidic linkages, a reducing sugar content of less than 20%, a weight-average molecular weight MW of between 4000 and 6000 g/mol and a number-average molecular weight Mn of between 250 and 4500 g/mol.

Certain subfamilies of branched maltodextrins described in the abovementioned application can also be used in accordance with the invention. They are, for example, high-molecular-weight branched maltodextrins having a reducing sugar content at most equal to 5 and an Mn of between 2000 and 4500 g/mol. Low-molecular-weight branched maltodextrins having a reducing sugar content of between 5 and 20% and a molecular weight Mn of less than 2000 g/mol can also be used.

In the present application, the pyrodextrins denote the products obtained by heating starch brought to a low moisture content, in the presence of acid or basic catalysts, and which generally have a molecular weight of between 1000 and 6000 daltons. This dry roasting of the starch, most commonly in the presence of acid, leads to both depolymerization of the starch and rearrangement of the starch fragments obtained, resulting in highly branched molecules being obtained. This definition targets in particular the “indigestible” dextrins, having an average molecular weight of about 2000 daltons. Polydextrose is a soluble fibre produced by thermal polymerization of dextrose, in the presence of sorbitol and of acid as catalyst. An example of such a product is, for example, Litesse® sold by Danisco.

According to one particularly advantageous embodiment of the present invention, the composition for a gluten-free baked product comprises Nutriose®, which is an entire range of soluble fibres, recognized for their benefits, and produced and sold by the applicant. The products of the Nutriose® range are partially hydrolyzed wheat starch or corn starch derivatives which contain up to 85% fibre. This richness in fibre makes it possible to increase the digestive tolerance, to improve calorie control, to prolong energy release and to obtain a lower sugar content. In addition, the Nutriose® range is one of the most well-tolerated fibres available on the market. It shows higher digestive tolerance, allowing better incorporation than other fibres, thereby representing real dietary advantages.

According to one particularly advantageous embodiment, the composition for a gluten-free baked product according to the present invention also comprises proteins of vegetable origin.

In the present invention, the term “vegetable protein” denotes all proteins derived from cereals, from oleaginous plants, from leguminous plants and from tuberous plants.

In the present invention, the term “vegetable protein” also denotes all proteins derived from algae and from microalgae.

These vegetable proteins can be used alone or as mixtures, chosen from the same family or from different families. Thus, the composition for a gluten-free baked product according to the invention is characterized in that the vegetable protein that it comprises is a protein derived from the family of cereals, oleaginous plants, leguminous plants, tuberous plants, algae and microalgae, used alone or as a mixture, chosen from the same family or from different families.

In the present application, the terms “algae” and “microalgae” are intended to mean eukaryotic organisms devoid of roots, stalks and leaves, but having chlorophyll and also other pigments that are incidental to oxygen-producing photosynthesis. They are blue, red, yellow, golden and brown, or else green. They represent more than 90% of marine plants and 18% of the plant kingdom, with their 40 000 to 45 000 species. Algae are organisms that are extremely varies both in terms of their size and shape and in terms of their cell structure. They live in an aquatic or very humid environment. They contain many vitamins and trace elements, and are true concentrates of active agents that are stimulants of and beneficial to health and beauty. They have anti-inflammatory, moisturizing, softening, regenerating, firming and anti-ageing properties. They also have “technological” characteristics which make it possible to give a food product texture. Indeed, much-vaunted additives E400 to E407 are in fact merely compounds extracted from algae, the thickening, gelling, emulsifying and stabilizing properties of which are used. Microalgae in the strict sense are undifferentiated single-cell or multicellular microscopic algae; they are photosynthetic microorganisms separated into two polyphyletic groups: eukaryotes and prokaryotes. As they live in strongly aqueous environments, they can have a flagellar motility.

According to one preferential embodiment, the microalgae are chosen from the group made up of Chlorella, Spirulina and Odontella.

According to one even more preferential embodiment, the microalgae used according to the present invention are derived from the Chlorella genus, and preferably from Chlorella vulgaris, Chlorella pyrenoidosa, Chlorella regularis, or Chlorella sorokiniana, and even more preferentially from Chlorella vulgaris.

In the present application, the term “cereals” is intended to mean cultivated plants of the grass family producing edible grains, for instance wheat, oats, rye, barley, maize, sunflower, sorghum or rice. The cereals are often milled in the form of flour, but are also provided as grains and sometimes in whole-plant form (fodders).

In the present application, the term “tubers” is intended to mean all the storage organs, which are generally underground, which ensure plants' survival during the winter season and often their multiplication by the vegetative process. These organs are bulbous owing to the accumulation of storage substances. The organs transformed into tubers can be:
the root: carrot, parsnip, cassaya, konjac,
the rhizome: potato, Jerusalem artichoke, Japanese artichoke, sweet potato,
the base of the stalk (more specifically the hypocotyl): kohlrabi, celeric,
the root+hypocotyl combination: beetroot, radish.

In the present application, the term “oleaginous plant” denotes plants cultivated specifically for their seeds or their fruits rich in fats, from which oil for dietary, energy or industrial use is extracted, for instance rapeseed, groundnut, sunflower, soybean, sesame and the castor oil plant.

For the purpose of the present invention, the term “leguminous plants” is intended to mean any plants belonging to the family Caesalpiniacae, the family Mimosaceae or the family Papilionaceae, and in particular any plants belonging to the family Papilionaceae, for instance pea, bean, broad bean, horse bean, lentil, alfalfa, clover or lupin.

This definition includes in particular all the plants described in any one of the tables contained in the article by R. Hoover et al., 1991 (Hoover R. (1991) “Composition, structure, functionality and chemical modification of legume starches: a review” Can. J. Physiol. Pharmacol., 69 pp. 79-92).

According to one preferential embodiment of the present invention, the vegetable protein belongs to the leguminous plant proteins.

According to another preferential embodiment, the leguminous plant protein is chosen from the group comprising pea, bean, broad bean and horse bean, and mixtures thereof. According to another preferential embodiment, the leguminous plant protein is chosen from the group comprising alfalfa, clover, lupin, pea, bean, broad bean, horse bean and lentil, and mixtures thereof, preferably from pea, bean, broad bean and horse bean, and mixtures thereof.

Even more preferably, said leguminous plant protein is pea.

The term “pea” is here considered in its broadest sense, and includes in particular:
all the wild-type varieties of smooth pea and of wrinkled pea, and
all mutant varieties of smooth pea and of wrinkled pea, irrespective of the uses for which said varieties are generally intended (food for human consumption, animal feed and/or other uses).

Said mutant varieties are in particular those known as “r mutants”, “rb mutants”, “rug 3 mutants”, “rug 4 mutants”, “rug 5 mutants” and “lam mutants” as described in the article by C-L Heydley et al., entitled “Developing novel pea starches” Proceedings of the Symposium of the Industrial Biochemistry and Biotechnology Group of the Biochemical Society, 1996, pp. 77-87.

Even more preferentially, said leguminous plant protein is smooth pea.

Indeed, the pea is the leguminous plant with protein-rich seeds which, since the 1970s, has been most widely developed in Europe and mainly in France, not only as a protein source for animal feed, but also for food for human consumption.

The pea proteins are, like all leguminous plant proteins, made up of three main classes of proteins: globulins, albumins and “insoluble” proteins.

The value of pea proteins lies in their good emulsifying capacities, their lack of allergenicity and their low cost, which makes them an economical functional ingredient.

Furthermore, the pea proteins contribute favourably to sustainable development and their carbon impact is very positive. This is because pea cultivation is environmentally friendly and does not require nitrogenous fertilizers, since the pea fixes nitrogen from the air. According to the present invention, the term “pea protein” preferably denotes the pea proteins which are mainly in native, globular form, globulins, or albumins. Even more preferentially, the pea proteins used according to the invention are in the form of a composition of pea protein having:
a total protein content (N×6.25), expressed in grams of dry product, of at least 60% by weight of dry product. Preferably, in the context of the present invention, use is made of a protein composition having a high protein content of between 70% and 97% by weight of dry product, preferably between 76% and 95%, even more preferentially between 78% and 88%, and in particular between 78% and 85%,
a soluble protein content, expressed according to a test for measuring the water-solubility of the proteins, of between 20 and 99%. Preferably, in the context of the present invention, use is made of a protein composition having a high soluble protein content of between 45 and 90%, even more preferentially between 50 and 80%, and in particular between 55 and 75%.

In order to measure the total protein content, the soluble nitrogenous fraction contained in the sample can be quantitatively determined according to the Kjeldahl method, and then the total protein content is obtained by multiplying the nitrogen content, expressed as percentage by weight of dry product, by the factor 6.25. This method is well known to those skilled in the art.

In the present invention, the total protein content can also be measured by quantitatively determining the soluble nitrogenous fraction contained in the sample according to the method of A. Dumas, as described by Buckee, 1994, in Journal of the Institute of Brewing, 100, pp 57-64, and then the total protein content is obtained by multiplying the nitrogen content, expressed as percentage by weight of dry product, by the factor 6.25. This method, also known as the combustion method for determining nitrogen, consists of total combustion of the organic matrix under oxygen. The gases produced are reduced by copper and then dried, and the carbon dioxide is trapped. The nitrogen is then quantified using a universal detector. This method is well known to those skilled in the art.

To determine the soluble protein content, the content of proteins soluble in water of which the pH is adjusted to 7.5+/−0.1 using a solution of HCl or NaOH is measured by means of a method of dispersion of a test specimen of the sample in distilled water, centrifugation and analysis of the supernatant. 200.0 g of distilled water at 20° C.+/−2° C. are placed in a 400 ml beaker, and the whole is stirred magnetically (magnetic bar and rotation at 200 rpm). Exactly 5 g of the sample to be analysed are added. The mixture is stirred for 30 min, and centrifuged for 15 min at 4000 rpm. The method for determining nitrogen is carried out on the supernatant according to the method previously described.

These vegetable protein, and in particular pea protein, compositions preferably contain more than 50, 60, 70, 80 or 90% of proteins of more than 1000 Da. In addition, these vegetable protein, in particular pea protein, compositions preferably have a molecular weight distribution profile consisting of:
1 to 8%, preferably from 1.5 to 4%, and even more preferentially from 1.5 to 3% of proteins of more than 100 000 Da,
20 to 55%, preferably from 25 to 55% of proteins of more than 15 000 and of at most 100 000 Da,
15 to 30% of proteins of more than 5000 and of at most 15 000 Da,
and from 25 to 55%, preferably from 25 to 50%, and even more preferentially from 25 to 45% of proteins of at most 5000 Da.

The determination of the molecular weights of the constitutive proteins of said pea protein compositions is carried out by size exclusion chromatography under denaturing conditions (SDS+2-mercaptoethanol); the separation is carried out according to the size of the molecules to be separated, the molecules of large size being eluted first.

Examples of pea protein compositions according to the invention, and also the details of the method for determining the molecular weights, can be found in patent WO 2007/017572, of which the applicant company is also the proprietor.

According to the present invention, said vegetable proteins, and in particular pea proteins, used for producing the composition for a gluten-free baked product can also be “vegetable protein concentrates” or “vegetable protein isolates”, preferably “pea protein concentrates” or “pea protein isolates”. The vegetable protein, and in particular pea protein, concentrates and isolates are defined from the viewpoint of their protein content (cf. the review by J. Gueguen from 1983 in Proceedings of European congress on plant proteins for human food (3-4) pp 267-304):
the vegetable protein, and in particular pea protein, concentrates are described as having a total protein content of from 60 to 75% on a dry basis, and
the vegetable protein, and in particular pea protein, isolates are described as having a total protein content of from 90 to 95% on a dry basis, the protein contents being measured by the Kjeldhal method (cf. above), the nitrogen content being multiplied by the factor 6.25.

In another embodiment of the present invention, the vegetable protein, and in particular pea protein, compositions that can be used may also be “vegetable protein hydrolysates” (VPH), preferably “pea protein hydrolysates”. The vegetable protein, and in particular pea protein, hydrolysates are defined as preparations obtained by enzymatic hydrolysis or chemical hydrolysis, or by both simultaneously or successively, of vegetable proteins, and in particular pea proteins. The protein hydrolysates are composed of a mixture of peptides of various sizes and of free amino acids. This hydrolysis can have an impact on the solubility of the proteins. The enzymatic and/or chemical hydrolysis is, for example, described in patent application WO 2008/001183. Preferably, the protein hydrolysis is not complete, i.e. does not result in a composition comprising only or essentially amino acids and small peptides (from 2 to 4 amino acids). Thus, the hydrolysates according to the invention are not VPH compositions. The preferred hydrolysates comprise more than 50, 60, 70, 80 or 90% of proteins of more than 500 Da.

The processes for preparing protein hydrolysates are well known to those skilled in the art and can, for example, comprise the following steps: dispersion of the proteins in water so as to obtain a suspension, hydrolysis of this suspension by means of the chosen treatment. Most commonly, it will be an enzymatic treatment combining a mixture of various proteases, optionally followed by a thermal treatment intended to inactivate the enzymes that are still active. The solution obtained can then be filtered through one or more membranes so as to separate the insoluble compounds, optionally the residual enzyme, and the high-molecular-weight peptides (greater than 10 000 daltons).

According to one advantageous embodiment of the invention, the composition for a gluten-free baked product comprises a pregelatinized native starch, fibres of vegetable origin chosen from leguminous plant fibres, a non pregelatinized or non precooked gluten-free starch and proteins of vegetable origin.

According to one advantageous embodiment of the present invention, the composition comprises pea proteins, and at least one vegetable fibre chosen from leguminous plant fibres.

According to another advantageous embodiment of the present invention, the composition for a gluten-free baked product comprises proteins of vegetable origin, and preferably pea proteins, and at least one insoluble vegetable fibre chosen from leguminous plant fibres.

According to another particularly advantageous embodiment of the present invention, the composition for a gluten-free baked product comprises proteins of vegetable origin, and preferably pea proteins, and a mixture of at least one soluble vegetable fibre and one insoluble vegetable fibre chosen from leguminous plant fibres. According to one particularly advantageous feature of the invention, said leguminous plant from which the leguminous plant fibres and the leguminous plant proteins are derived is selected from the group comprising alfalfa, clover, lupin, pea, bean, broad bean, horse bean, lentil and mixtures thereof. Thus, the invention relates in particular to a granulated powder comprising proteins and fibres derived from a leguminous plant selected from the group comprising alfalfa, clover, lupin, pea, bean, broad bean, horse bean, lentil and mixtures thereof, preferably derived from pea.

According to a first variant, said composition for a gluten-free baked product comprises pea proteins and at least one insoluble vegetable fibre chosen from pea fibres.

The composition for a gluten-free baked product according to the invention may also comprise an insoluble vegetable fibre chosen from the group made up of resistant starches, cereal fibres, fruit fibres, fibres from vegetables and mixtures thereof. Mention may, for example, be made of fibres such as bamboo or carrot fibres.

According to a second variant, the composition for a gluten-free baked product comprises a mixture of at least one resistant starch and one pea fibre. Natural resistant starches or resistant starches obtained by chemical and/or physical and/or enzymatic modification may be used without distinction.

According to the present invention, the term “resistant starch” denotes a starch or a starch fraction which is not digested in the small intestine and which is fermented by the bacteria of the colon. Four categories of resistant starch have been identified:
encapsulated starches, present in most unrefined vegetable foods such as dry vegetables, said starches being inaccessible to enzymes (RS1),
the granular starch of certain raw foods, such as banana or potato, and amylose-rich starches (RS2),
retrograded starches, which are found in foods which have been cooked and then refrigerated or frozen (RS3),
chemically modified starches such as, in particular, etherified or esterified starches (RS4).

The resistant starches proposed, in particular, by the company National Starch, such as those sold under the name Hi-Maize®, are derived from maize varieties rich in amylose and behave like insoluble fibres. RS3-type resistant starches are also proposed under the name Novelose®.

These resistant starches reduce the glycemic response, improve the health of the digestive system by virtue of their prebiotic properties and contribute to the regularity of transit, without having a high calorie content.

Preferably, a resistant starch derived from starch having an amylose content of greater than 50% will be used. The Eurylon® amylose-rich starches sold by the applicant are particularly suitable.

According to another particularly advantageous embodiment of the invention, said composition for a gluten-free baked product comprises pea proteins and a mixture of soluble and insoluble fibres; the soluble fibres being advantageously branched maltodextrins and the insoluble fibres being chosen from leguminous plant fibres optionally mixed with resistant starches.

In the present invention, depending on the content of vegetable fibres incorporated into said gluten-free baked product, the final product may even comprise the designation “source of fibres” or “rich in fibres” depending on its final fibre content. Depending on the regulatory citations enforced, when the final product contains a fibre content of greater than 1.5 g per 100 g of product, it will be labelled as being a “source of fibres”. If its fibre content is greater than 3 g per 100 g of final product, it will be termed rich in fibres. This benefit of fibre intake merely reinforces the nutritional advantage of the baked product according to the present invention. Indeed, the role of fibres is important in intestinal transit since they increase bolus volume and change stool consistency (thus making the stools softer) owing to their water-retaining capacity, stimulate intestinal contractions and promote bacterial activity in the colon. A fibre deficiency can lead to gastric and intestinal problems: constipation or diarrhoea. Fibres also have a positive satiety-accelerating effect, delay the feeling of hunger, and thus limit the risk of overeating, thereby helping to prevent obesity. What is more, a fibre-rich diet would reduce overall mortality, cardiovascular mortality, mortality caused by respiratory disease or mortality caused by infection. Finally, a fibre-rich diet also contributes to reducing the blood cholesterol level, with is liable to prevent coronary artery diseases, and also reduces the risk of gallstone formation. Indeed, bile salts are cholesterol degradation products formed in the liver and secreted via the bile at a rate of 30 g per day. Fibres, by binding with a part of these bile salts (and with cholesterol molecules secreted in the bile), facilitate their evacuation in the stools.

Thus, there are many advantages to the composition for a baked product according to the present invention. It makes it possible to produce totally gluten-free products which can therefore be consumed by individuals suffering from coeliac disease. According to one preferential embodiment, said baked products can also be totally devoid of additives, unlike the gluten-free baked products traditionally found on the market. They are also enriched in fibres and therefore provide a nutritional supplement beneficial to health.

Finally, another major advantage of the present invention lies in the processing and the use of said composition.

Owing to the various components of said composition for a gluten-free baked product according to the present invention, it is no longer necessary to make modifications to the production process, more particularly to the breadmaking process.

Indeed, as previously explained, many gluten-free breads of the prior art contain hydrocolloids, and their presence in the dough implies an adaptation of the amount of water in the recipe in order to make it possible to correctly hydrate all the other soluble compounds also present. Indeed, hydrocolloids are additives that it is necessary to strongly hydrate in order to develop their properties. Thus, the amount of water will have to be increased up to 100 g, or even 120 g, per 100 g of “flour” used. The hydration rate of a dough of a gluten-free bread is from 1 to 1.2. When a conventional flour-based bread containing gluten is produced, the hydration rate is between 0.5 and 0.7, i.e. between 50 g and 70 g of water per 100 g of flour used.

Thus, the doughs of gluten-free breads are very strongly hydrated and are therefore runny. Moreover, in order to prevent the dough from spreading during baking, the current gluten-free breads are baked in moulds. This major disadvantage does not allow the use of a conventional breadmaking process similar to that used in the production of a traditional bread. This constitutes another concern for manufacturers, who are obliged to modify their industrial process, both in terms of the recipes and in terms of the virtually obligatory use of moulds in the production line.

One of the major advantages of the present invention is that the hydration rate of the dough obtained from said composition is similar to the hydration rate obtained when using a recipe containing gluten, i.e. between 0.5 and 0.7, i.e. between 50 g and 70 g of water per 100 g of flour used, compared with 1 to 1.2, traditionally observed in the gluten-free bread processes of the prior art. This also makes it possible to shape the dough and to give the various baked products, and more particularly breadmaking products, obtained the more appetizing appearance of a baguette, for example.

The present invention also relates to the gluten-free and optionally additive-free doughs, intended to be baked, and obtained by using the composition according to the present invention in recipes, from the mixing of said composition with the other ingredients to the formation of said dough.

The present invention also relates to the gluten-free and optionally additive-free baked products obtained by baking this said dough.

Thus, the gluten-free baked products obtained by using the composition according to the present invention can be prepared under the usual production conditions. No modification of the production processes is necessary, and the use of moulds for baking the dough is absolutely not required.

More specifically, when the baked products are breadmaking products, the latter are obtained under the usual traditional breadmaking conditions.

What is more, the final organoleptic characteristics of the baked product according to the present invention are in all respects identical to the conventional baked product that would contain gluten. No major modification of the functional, sensory and organoleptic properties of the baked products according to the present invention is to be noted.

The present invention also relates to the use of a pregelatinized or precooked native starch, of fibres of vegetable origin chosen from leguminous plant fibres, and optionally of proteins of vegetable origin, in the production of a baked product intended to be eaten by individuals suffering from coeliac disease.

According to one preferential embodiment of this use, the fibres of vegetable origin chosen from leguminous plant fibres are pea fibres.

One of the final aspects of the present invention is that it also relates to a ready-to-use mix for the home production of a baked product intended to be eaten by individuals suffering from coeliac disease, characterized in that it comprises a pregelatinized or precooked native starch, fibres of vegetable origin chosen from leguminous plant fibres, and optionally proteins of vegetable origin.

According to one particular embodiment, the mix may in addition contain other ingredients in powder form, such as yeast, for example.

The invention will be understood more clearly on reading the examples which follow, which are intended to be illustrative, referring only to certain embodiments and certain advantageous properties according to the invention, and non-limiting.

### Example 1

### Various Formulas of Recipes for Gluten-Free and Optionally Additive-Free Breads

The objective is to be able to make breads containing no gluten and no additives, under usual traditional breadmaking conditions.

### A. Formula (Ingredients Expressed as Weight Percentage)

| | | | Formula | Formula |
|---|---|---|---|---|
| | Formula 1 | Formula 2 | 3 | 4 |
| | Source of | Source de | Rich in | Rich in |
| INGREDIENTS | fibres | fibres | fibres | fibres |
| PREGEFLO P100 | 220 | 220 | 220 | 220 |
| I50M Pea fibre | 180 | 180 | 180 | 180 |
| NUTRIOSE FB06 | 0 | 0 | 40 | 40 |
| NUTRALYS F85M | 28 | 28 | 28 | 28 |
| Potato flour | 200 | 0 | 180 | 0 |
| Std corn starch | 408 | 0 | 388 | 0 |
| GF (gluten free) | 0 | 608 | 0 | 568 |
| wheat starch | | | | |
| Dextrose | 60 | 60 | 60 | 60 |
| Salt | 28 | 28 | 28 | 28 |
| Rapeseed oil | 60 | 60 | 60 | 60 |
| Pressed yeast | 56 | 56 | 56 | 56 |
| Water | 760 | 760 | 760 | 760 |
| Total | 2000 | 2000 | 2000 | 2000 |

### B. Method

Introduce the various ingredients into the kneading machine.
Kneading for 4 minutes on speed 1, then 19 minutes on speed 2.
Bulk fermentation for 45 minutes in an oven at 23° C. and 80% relative humidity.
Cutting up, weighing, shaping.
Proving or proofing in an oven at 23° C., 80% RH for 1 h 30 to 1 h 45 min.

Baking in a hearth oven at 250° C. for 20 to 30 minutes until a lovely well-browned crust is obtained.

### Example 2

### Making a Gluten-Free Cake According to Two Recipes

This example makes it possible to demonstrate that the composition according to the invention makes it possible to broaden the range of gluten-free baked products to cake recipes.

### A. Formula (Ingredients Expressed as Weight Percentage)

| | Recipe 1 | Recipe 2 |
|---|---|---|
| INGREDIENTS | Content in g | Content in g |
| Butter | 170 | 170 |
| Sugar | 170 | 170 |
| Whole egg | 200 | 200 |
| Glycerol | 40 | 40 |
| Melted chocolate | 150 | 150 |
| Gluten-free wheat | 142 | — |
| starch | | |
| Corn starch | — | 57 |
| Potato starch | — | 85 |
| PREGEFLO PJ30 | 40 | 40 |
| I50M Pea fibre | 70 | 70 |
| Baking powder | 6 | 6 |
| Salt | 2 | 2 |
| Emulsifier: | 10 | 10 |
| SPONGOLIT 283 | | |
| TOTAL | 1000 | 1000 |

The emulsifier used is SPONGOLIT 283 sold by the company Cognis.

### B. Method

Mix the sugar with the butter.
Add the eggs and the glycerol while continuing to mix thoroughly.
Then incorporate the melted chocolate.
Next add the starches, followed by the pea fibres, the baking powder, the salt and the emulsifier.
As soon as the mixture is completely smooth and completely homogeneous, place it in a previously buttered cake mould.
Bake at 200° C. for 50 minutes, while monitoring the baking.
Leave to cool and remove from the mould once the cake is cold.

### C. Composition of the Final Product

Values for 100 g of final product

| | |
|---|---|
| Calories (kCal/kJ) | 446 kCal/1864 kJ |
| Proteins | 3.3 g |
| Fat content | 19.9 g |
| Carbohydrates | 36.8 g |
| Including the DP1, 2 | 21.2 g |
| Total fibre content | 2.2 g |
| Insoluble fibres | 2.2 g |
| Soluble fibres | 0 g |
| Polyols | 3.4 g |
| Glycerol | 3.4 g |

The two cakes obtained according to the two recipes above using the composition for a gluten-free baked product according to the present invention were tasted by a panel of tasters, and they were judged to have a very satisfactory and pleasant taste. Their texture was noted as being soft and moist.

### Example 3

### Making Gluten-Free Madeleines

This example makes it possible to demonstrate that the composition according to the invention makes it possible to broaden the range of gluten-free baked products to cake recipes.

### A. Formula (Ingredients Expressed as Weight Percentage)

| INGREDIENTS | Content in g |
|---|---|
| Whole egg | 200 |
| Sugar | 215 |
| Lemon liquid flavouring | 1.5 |
| M54227_MANE | |
| Water | 50 |
| Vegetable oil | 230 |
| Glycerol | 20 |
| Gluten-free wheat starch | 111 |
| Potato starch | 95 |
| PREGEFLO p100 | 10 |
| I50M Pea fibre | 55 |
| Baking powder | 8 |
| Butter flavouring | 2.5 |
| Salt | 2 |
| TOTAL | 1000 |

### B. Method

Mix the sugar with the eggs.
Add the liquid flavouring and the water and mix until a homogeneous mixture is obtained.
Then incorporate the oil and the glycerol.
Then add the starches, followed by the pea fibres, the baking powder, the butter flavouring and the salt.
As soon as the mixture is completely smooth and completely homogeneous, place it in small madeleine moulds.
Bake at 240-245° C. for two minutes then reduce the baking temperature to 200° C. until a lovely golden colour is obtained at the surface.
Leave to cool and remove from the moulds once the cake is cold.

The madeleines obtained according to the recipe above, using the composition for a gluten-free baked product according to the present invention, were tasted by a panel of tasters. They were judged to have a very satisfactory and pleasant taste. Their texture was noted as being soft and moist.

### Example 4

### Making Gluten-Free Pizza Dough

This example makes it possible to demonstrate that the composition according to the invention makes it possible to broaden the range of gluten-free baked products to dough recipes, and in particular pizza dough recipes.

a. Formula (Ingredients Expressed as Weight Percentage)

| INGREDIENTS | Content in g | % content |
|---|---|---|
| PREGEFLO p100 | 220 | 11.3 |
| I50M pea fibre | 180 | 9.3 |
| NUTRALYS F85M | 30 | 1.5 |
| Gluten-free wheat | 570 | 29.3 |
| starch | | |
| Dextrose | 10 | 0.5 |
| Salt | 30 | 1.5 |
| Dehydrated yeast | 10 | 0.5 |
| Olive oil | 100 | 5.1 |
| Water | 800 | 41 |
| TOTAL | 1950 | 100% |

### B. Method

Mix all the dry ingredients together in a mixer for 30 seconds, on low.
Add the water and the oil and mix for 4 minutes at more energetic speed until a completely homogeneous dough is obtained.
Cut up into 350 g dough pieces.
Bulk fermentation for 50 minutes in an oven at 30° C. and 75% relative humidity.
Preparation of the pizza base by rolling it out with a roller.
Topping with the desired ingredients.
Baking the pizza in an oven at 220° C. for approximately 20 minutes.

The pizzas obtained are identical to pizzas obtained with a conventional dough containing gluten.

The quality of the dough was tasted after baking, without topping, and was judged to be very satisfactory and in accordance with a “conventional” pizza dough.

### Example 5

### Making Gluten-Free Croissants

This example makes it possible to demonstrate that the composition according to the invention makes it possible to broaden the range of gluten-free baked products to dough recipes, and in particular puff pastry dough recipes for, inter alia, making croissants.

### A. Formula (Ingredients Expressed as Weight Percentage)

| INGREDIENTS | Content in g | % content |
|---|---|---|
| PREGEFLO p100 | 120 | 12.5 |
| Gluten-free wheat starch | 240 | 25 |
| I50M pea fibre | 30 | 3.1 |
| Dehydrated egg albumin | 40 | 4.2 |
| Sucrose | 60 | 6.3 |
| Salt | 8 | 0.8 |
| Dehydrated yeast | 11 | 1.1 |
| Water | 220 | 22.9 |
| Butter (containing 82% | 230 | 24.1 |
| fat) | | |
| TOTAL | 959 | 100 |

### B. Method

Mix all the dry ingredients together in a mixer (of Hobart type) for 30 seconds, on low.
Add the water and mix for 1 minute at low speed (speed 1 on a mixer of Hobart type) then for 2 minutes at faster speed (speed 2 on the Hobart mixer).
Laminate the butter in a laminating machine until a thickness of 10 mm is obtained.
Laminate the pastry dough to a thickness of 8 mm.
Integrate the butter into the pastry dough.
Perform several laminations of the pastry dough-butter mixture: 20 mm, then 12 mm, then 8 mm and finally 6.5 mm.
End with a simple turn (fold the pastry dough in three).
Leave everything to stand in the cool at 4° C. for 30 minutes.
Perform two simple turns according to the same technique as previously.
Then laminate until a pastry dough 5 mm thick is obtained and shape the croissants.
Bulk fermentation for 1 hour in an oven at 30° C. and 75% relative humidity.
Baking in an oven at 190° C. for approximately 20 minutes.

The croissants obtained according to the above recipe, using the composition for a gluten-free baked product according to the present invention, were tasted by a panel of tasters. Their taste and especially their flakiness were judged to be very satisfactory and pleasant. Their texture was noted as being flaky on the outside, and soft and moist at the centre.

### Example 6

### Making Gluten-Free Cookies with Double Chocolate Inclusions

This example makes it possible to demonstrate that the composition according to the invention makes it possible to broaden the range of gluten-free baked products to cookie or biscuit recipes.

### A. Formula (Ingredients Expressed as Weight Percentage)

| INGREDIENTS | Content in g | % content |
|---|---|---|
| Part A | | |
| Softened butter | 85 | 13.8 |
| Brown sugar | 85 | 13.8 |
| Sucrose | 50 | 8.1 |
| Part B | | |
| Whole eggs | 35 | 5.7 |
| Part C | | |
| PREGEFLO p100 | 120 | 19.5 |
| Gluten-free wheat | 100 | 16.3 |
| starch | | |
| NUTRALYS F85M | 20 | 3.2 |
| I50M pea fibre | 30 | 4.9 |
| Salt | 1.5 | 0.2 |
| Sodium bicarbonate | 2.5 | 0.5 |
| Butter flavouring | 0.5 | 0.1 |
| Vanilla flavouring | 0.5 | 0.1 |
| Part D | | |
| Chocolate chips | 60 | 9.7 |
| Part D′ | | |
| Chocolate chips | 25 | 4.1 |
| TOTAL | 615 | 100 |

### B. Method

Mix all the ingredients of part A in a mixer (of Hobart type) for 30 seconds on low speed (speed 1 on a mixer of Hobart type) and then for 2 minutes at a faster speed (speed 2 on the Hobart mixer).
Add part B and mix under the same conditions as previously.
Add the ingredients of part C and mix under the same conditions as previously.
Add the chocolate chips of part D and mix for 30 seconds on low.
Form the cookies with a spoon using approximately 35 g of cookie dough for large cookies.
Add the chocolate chips of part D′ to the top of the preformed cookies.
Bake in a rotary oven at 170° C. for approximately 8 minutes.

The cookies obtained according to the above recipe, using the composition for a gluten-free baked product according to the present invention, were tasted by a panel of tasters. Their taste and especially their texture were judged to be very satisfactory and pleasant. Their texture was noted as being crunchy on the outside and moist at the centre.

The numerous examples above demonstrate perfectly that the present invention is of very varied interest in a large number of applications in the bread and pastry fields.

By virtue of the present invention, it is now possible to offer a very large panel of recipes to people who do not want to consume gluten, by obtaining final products of a quality that is at least identical to the conventional products made with gluten.

1-16. (canceled)

17. Composition for a gluten-free baked product comprising:
a pregelatinized or precooked native starch,
fibres of vegetable origin chosen from leguminous plant fibres.

18. Composition according to claim 17, characterized in that it comprises a non pregelatinized or non precooked gluten-free starch.

19. Composition according to claim 18, characterized in that the gluten-free starch used is chosen from the group made up of unmodified gluten-free starches, modified gluten-free starches or a mixture thereof.

20. Composition according to claim 17, characterized in that it also comprises a protein of vegetable origin.

21. Composition according to claim 17, characterized in that it does not comprise additives.

22. Composition according to claim 17, characterized in that the content of pregelatinized or precooked native starch is between 2 and 50%, preferably between 5 and 30%, and more preferentially between 7 and 18% of the total weight of the ingredients used in said composition.

23. Composition according to claim 17, characterized in that the content of fibres of vegetable origin is between 2 and 50%, preferably between 5 and 30%, and more preferentially between 7 and 18% of the total weight of the ingredients used.

24. Composition according to claim 17, characterized in that the content of proteins of vegetable origin is between 0.5 and 20%, preferably between 0.8 and 10%, and more preferentially between 1 and 7% of the total weight of the ingredients used.

25. Composition according to claim 17, characterized in that the fibres of vegetable origin are chosen from fibres of a leguminous plant selected from the group consisting of alfalfa, clover, lupin, pea, bean, broad bean, horse bean, lentil and mixtures thereof.

26. Composition according to claim 17, characterized in that the vegetable protein is a protein derived from the family of cereals, oleaginous plants, leguminous plants, tuberous plants, algae and microalgae, used alone or as a mixture, chosen from the same family or from different families, the vegetable protein preferably belonging to the leguminous plant proteins, said leguminous plant being more preferentially selected from the group consisting of alfalfa, clover, lupin, pea, bean, broad bean, horse bean and lentil, and mixtures thereof.

27. Composition according to claim 17, characterized in that it comprises proteins and fibres derived from a leguminous plant selected from the group consisting of alfalfa, clover, lupin, pea, bean, broad bean, horse bean, lentil and mixtures thereof.

28. Composition according to claim 27, characterized in that the leguminous plant is pea.

29. Gluten-free dough intended to be baked, and obtained by using the composition according to claim 17 in recipes.

30. Gluten-free baked product obtained by baking the dough according to claim 29.

31. A method for the production of a baked product intended to be eaten by individuals suffering from coeliac disease comprising baking a composition comprising a pregelatinized or precooked native starch, fibres of vegetable origin chosen from leguminous plant fibres, and optionally proteins of vegetable origin.

32. Ready-to-use mix for the home production of a baked product intended to be eaten by individuals suffering from coeliac disease, characterized in that it comprises a pregelatinized or precooked native starch, fibres of vegetable origin chosen from leguminous plant fibres, and optionally proteins of vegetable origin.
